(19) United States
(12) Patent Application Publication
(10) Pub. No.: US 2010/0132196 A1
(43) Pub. Date: Jun. 3, 2010

(54) METHOD OF MANUFACTURING INK-JET HEAD

(75) Inventors: Ju-Hwan Yang, Suwon-si (KR); Jae-Woo Joung, Suwon-si (KR); Young-Seuck Yoo, Seoul (KR); Boum-Seock Kim, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/541,570

(22) Filed: Aug. 14, 2009

(30) Foreign Application Priority Data
Dec. 3, 2008 (KR) 10-2008-0121663

(51) Int. Cl. B23P 17/00

(52) U.S. Cl. 29/890.1

(57) ABSTRACT

Disclosed is a method of manufacturing an ink-jet head including a plurality of chambers, a membrane covering the plurality of chambers, and a plurality of actuators separated from one another by a virtual dividing line on the membrane such that pressure is applied to each of the plurality of chambers. The method in accordance with an embodiment of the present invention includes: forming a groove at a position on one surface of a piezoelectric member, the position corresponding to the position of the dividing line; bonding the one surface of the piezoelectric member to the membrane, the one surface of the piezoelectric member having the groove formed therein; and processing the other surface of the piezoelectric member such that the groove is exposed.

### CROSS-REFERENCE TO RELATED APPLICATIONS

This application claims the benefit of Korean Patent Application No. 10-2008-0121663, filed with the Korean Intellectual Property Office on Dec. 3, 2008, the disclosure of which is incorporated herein by reference in its entirety.

### BACKGROUND

1. Technical Field

The present invention relates to a method of manufacturing an ink-jet head.

2. Description of the Related Art

The ink-jet printer can perform printing by converting an electrical signal into a physical force and ejecting ink droplets through a nozzle. The ink-jet head can be manufactured by processing various components such as a chamber, a restrictor, a nozzle, a piezoelectric member, etc., on each corresponding layer and bonding the layers together.

Recently, the ink-jet head is increasingly used not only in the conventional graphic ink-jet industry for printing on the paper and fiber but also in the manufacture of electronic components, for example, a printed substrate and an LCD panel.

As a result, the ink-jet printing technology for an electronic component, which requires more accurate and precise discharge of functional ink than the conventional graphic printing, requires functions that have not been required for the conventional ink-jet head. Besides the basic requirement for the size of the discharged ink droplet and ink droplet speed variation, high density nozzles and high-frequency properties are required for increasing the production. In order to satisfy such requirement, thinner actuators of the ink-jet head needed to be developed.

FIG. 1 is a front cross-sectional view showing an ink-jet head 12 according to a conventional technology. As shown in FIG. 1, in the past, after bonding a piezoelectric member to one surface of the ink-jet head, a dicing process was performed in order to actuate the piezoelectric member as an independent actuator 2 on each chamber 6.

Here, if each actuator 2 is severed completely, a silicon body of the ink-jet head 12 may get seriously stressed. If not severed completely due to such a problem, adjacent actuators 2 are linked with one another by residual piezoelectric member 3 as shown in FIG. 1, causing crosstalk.

Moreover, if the dicing process is performed twice by using a thin saw blade due to the consideration of stress on the silicon body of the ink-jet head, there remains a wall-shaped remnant 8 of the piezoelectric member between adjacent actuators, causing crosstalk.

### SUMMARY

The present invention provides a method of manufacturing an ink-jet head that can reduce crosstalk and have a thinner actuator.

An aspect of the present invention features a method of manufacturing an ink-jet head including a plurality of chambers, a membrane covering the plurality of chambers, and a plurality of actuators separated from one another by a virtual dividing line on the membrane such that pressure is applied to each of the plurality of chambers. The method in accordance with an embodiment of the present invention includes: forming a groove at a position on one surface of the piezoelectric member, the position corresponding to the position of the dividing line; bonding the one surface of the piezoelectric member to the membrane, the one surface of the piezoelectric member having the groove formed therein; and processing the other surface of the piezoelectric member such that the groove is exposed.

The bonding of the piezoelectric member can include forming a seating groove in the membrane and bonding the piezoelectric member to the seating groove. The processing of the other surface of the piezoelectric member can include polishing the other surface of the piezoelectric member. Here, the polishing of the other surface of the piezoelectric member can be performed such that the depth of the seating groove is the same as the height from the basal surface of the seating groove to the other surface of the piezoelectric member.

### BRIEF DESCRIPTION OF THE DRAWINGS

FIG. 1 is a front cross-sectional view showing an ink-jet head according to a conventional technology.

FIG. 2 is a cross-sectional view of a side of an ink-jet head manufactured according to an embodiment of the present invention.

FIG. 3 is a flowchart illustrating a method of manufacturing an ink-jet head according to an embodiment of the present invention.

FIGS. 4 through 9 show each respective process of a method of manufacturing an ink-jet head according to an embodiment of the present invention.

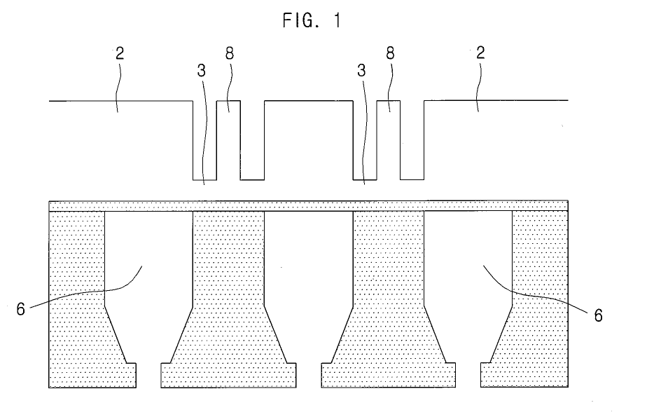

### DETAILED DESCRIPTION

As the present invention can have various embodiments and can be diversely changed, a specific embodiment will be illustrated in the drawings and described in detail. While the present invention is not limited to the particular embodiment, all modification, equivalents and substitutes included in the spirit and scope of the present invention are understood to be included therein.

Hereinafter, a certain embodiment of a method of manufacturing an ink-jet head in accordance with the present invention will be described in detail with reference to the accompanying drawings. In description with reference to accompanying drawings, the same reference numerals will be assigned to the same or corresponding elements, and redundant descriptions thereof will be omitted.

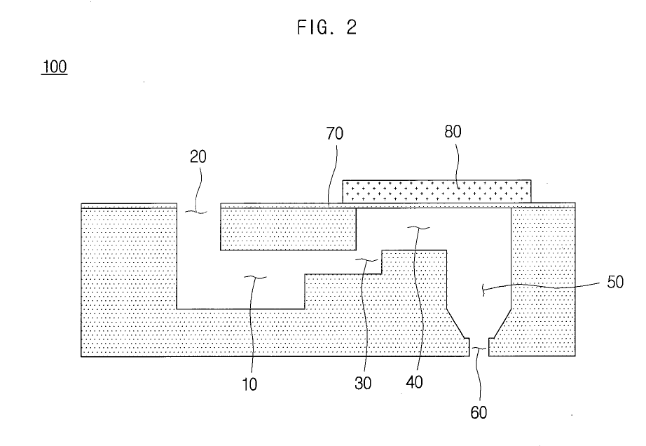

Before describing a method of manufacturing an ink-jet head in accordance with an embodiment of the present invention, each element of a piezoelectric type ink-jet head will be schematically described with reference to FIG. 2, which is a cross-sectional view of a side of an ink-jet head manufactured according to an embodiment of the present invention. Shown in FIG. 2 are a reservoir 10, an inlet port 20, a restrictor 30, a chamber 40, a damper 50, a nozzle 60, a membrane 70 and a piezoelectric member 80.

The chamber 40 accommodates ink. When the piezoelectric member 80, for example, which are formed on an upper surface of the membrane 70 applies pressure to the chamber 40, the chamber 40 transfers the accommodated ink in the direction of the nozzle 60 and causes the ink to be discharged. There can be a number of chambers, for example, 128 chambers, 256 chambers 40, etc., in parallel in one ink-jet head 100, and there can be an equal number of piezoelectric members 80 in order to provide pressure to each chamber 40. Here, each piezoelectric member 80 is arranged separately from another so that other adjacent chambers 40 are affected to a minimum. In the present specification, the space created by separation of the piezoelectric members 80 will be referred to as a dividing line.

The reservoir 10 is supplied with the ink from the outside through the inlet port 20 and stores the ink, and then provides the ink to the chamber 40 described above.

The restrictor 30 links the reservoir 10 and the chamber 40 and controls the ink flow generated between the reservoir 10 and the chamber 40. The restrictor 30 is formed to have a smaller cross sectional area than those of the reservoir 10 and the chamber 40. The restrictor 30 can control the amount of ink provided by the reservoir 10 to the chamber 40 when the membrane 70 is vibrated by the piezoelectric member 80.

The nozzle 60 is linked to the chamber 40 and is supplied with the ink from the chamber 40. Then the ink is ejected by the nozzle 60. If the vibration generated by the piezoelectric member 80 is delivered to the chamber 40 through the membrane 70, pressure is applied to the chamber 40, ejecting the ink through the nozzle 60.

The damper 50 is formed between the chamber 40 and the nozzle 60. The damper 50 can perform a function of converging the energy generated by the chamber 40 to the nozzle 60 and dampening a sudden change of pressure.

Meanwhile, an upper electrode (not shown) and a lower electrode (not shown) can be formed on the upper and lower sides of the piezoelectric member 80 in order to supply voltage to the piezoelectric member 80.

The ink-jet head 100 including the elements described above can be formed by stacking one or several substrates made of a silicon or ceramic material.

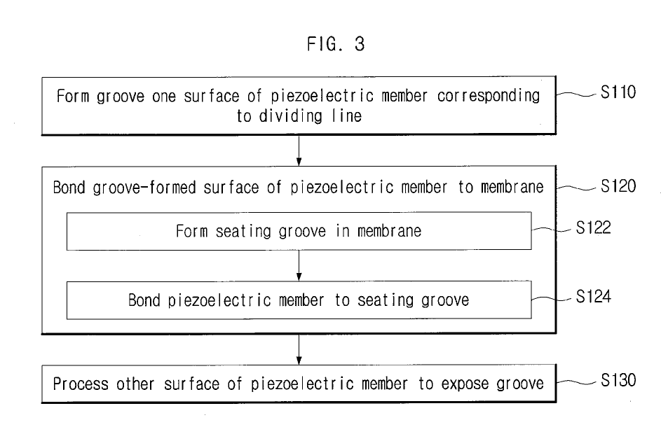

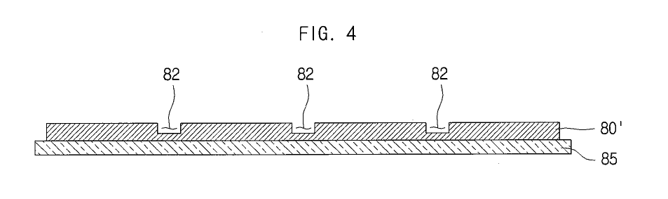

Hereinafter, a method of manufacturing an ink-jet head in accordance with an embodiment of the present invention will be described with reference to FIGS. 3 through 9. FIG. 3 is a flowchart illustrating a method of manufacturing an ink-jet head according to an embodiment of the present invention. FIGS. 4 through 9 show each respective process of a method of manufacturing an ink-jet head according to an embodiment of the present invention. Shown in FIGS. 4 through 9 are a chamber 40, a nozzle 60, a membrane 70, a seating groove 72, piezoelectric members 80 and 80′ and a groove 82.

First, the groove 82 is formed at a position of one surface of the piezoelectric member 80, the position corresponding to the position of the dividing line (S110, FIG. 4). That is, as shown in FIG. 4, a bulk type piezoelectric member 80′ is prepared, and then the groove 82 is formed at a position of a boundary line which divides the piezoelectric member 80 later, that is, the dividing line. Here, it shall be evident that a separate supporter 85 can be used.

In order to form the groove 82, a chemical method, such as a dry or wet etching, or a physical method using a saw blade and the like can be also used. The physical method can reduce the time required for the corresponding process.

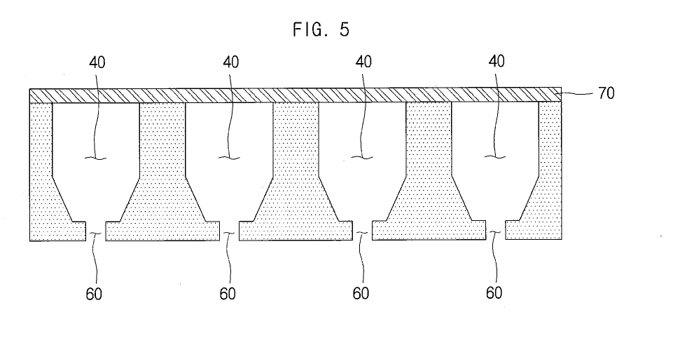

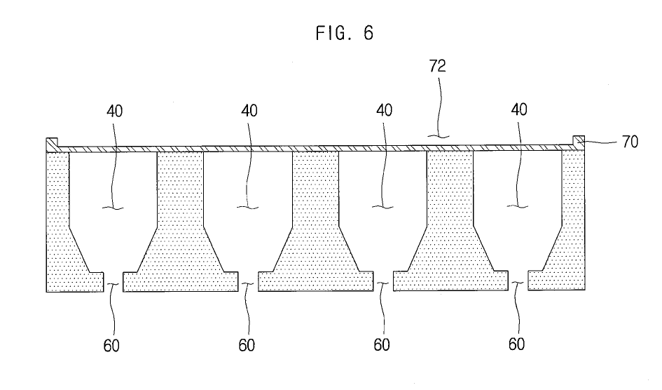

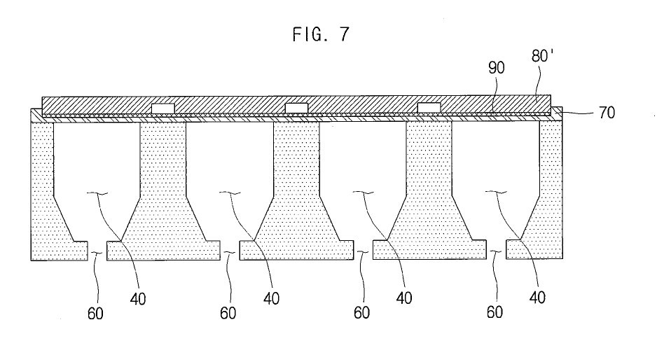

After forming the groove 82 in the bulk type piezoelectric member 80′, the membrane 70 is bonded to the one surface of the piezoelectric member 80′ having the groove 82 formed therein (S120). To this end, the seating groove 72 is formed in the membrane 70 (S122, FIGS. 5 and 6), and then the piezoelectric member 80′ can be bonded to the seating groove 72 (S124, FIG. 7). The forming of the seating groove 72 in the membrane 70 can reduce the thickness of the membrane 70. As a result, when the piezoelectric member 80 is actuated, the frequency characteristic can be improved and an actuating voltage can be also reduced.

Meanwhile, a separate adhesive 90 can be used for bonding the piezoelectric member 80′ and the membrane 70. While not shown in the drawings, it is also possible to directly bond the bulk type piezoelectric member 80′ to a membrane having no groove formed therein.

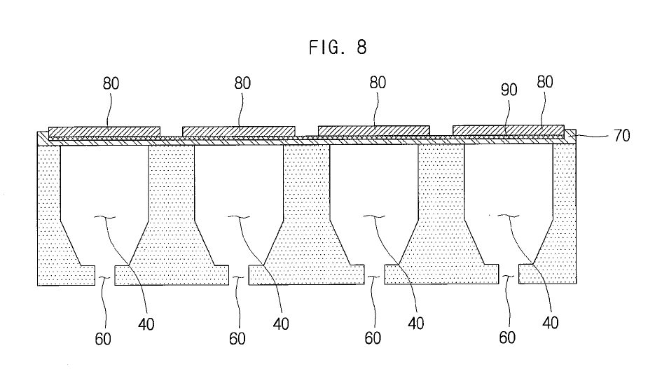

Then, the other surface of the piezoelectric member 80′ is processed such that the groove 82 is exposed (S130, FIG. 8). Through the process mentioned above, since the groove 82 is processed in the one surface of the piezoelectric member 80′, with which the membrane 70 is in contact, the other surface of the piezoelectric member 80′ is processed such that the groove 82 is exposed. Then, the bulk type piezoelectric member 80′ is divided into units of the piezoelectric member 80.

In order to expose the groove 82 by processing the other surface of the piezoelectric member 80′, only the other surface corresponding to the groove 82 can be selectively removed. The other surface of the piezoelectric member 80′ can be also polished until the groove 82 is exposed. The polishing of the other surface of the piezoelectric member 80′ can reduce the thickness of the piezoelectric member, reducing the actuating voltage.

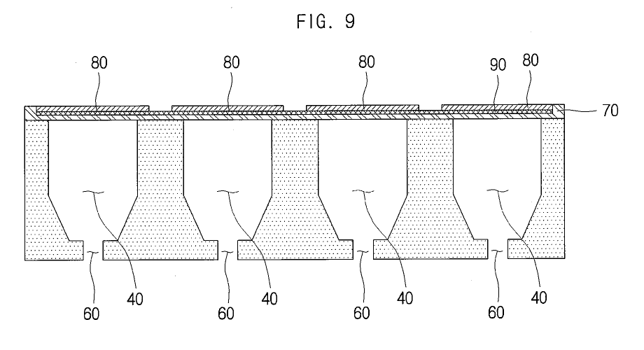

In addition, as shown in FIG. 9, if the piezoelectric member 80′ is polished such that the depth of the seating groove 72 is the same as the height from the basal surface of the seating groove 72 to the other surface of the piezoelectric member 80, there is no step difference on the upper surface of the membrane 70. Therefore, it can be expected that subsequent processes, such forming an upper electrode (not shown), become easier.

While the present invention has been described with reference to a certain embodiment thereof, it will be understood by those skilled in the art that various changes and modification in forms and details may be made without departing from the spirit and scope of the present invention as defined by the appended claims.

Numerous embodiments other than the embodiment described above are included within the scope of the present invention.

What is claimed is:

1. A method of manufacturing an ink-jet head including a plurality of chambers, a membrane covering the plurality of chambers, and a plurality of actuators separated from one another by a virtual dividing line on the membrane such that pressure is applied to each of the plurality of chambers, the method comprising:
forming a groove at a position on one surface of a piezoelectric member, the position corresponding to the position of the dividing line;
bonding the one surface of the piezoelectric member to the membrane, the one surface of the piezoelectric member having the groove formed therein; and
processing the other surface of the piezoelectric member such that the groove is exposed.

2. The method of claim 1, wherein the bonding of the piezoelectric member comprises:
forming a seating groove in the membrane; and
bonding the piezoelectric member to the seating groove.

3. The method of claim 1, wherein the processing of the other surface of the piezoelectric member comprises polishing the other surface of the piezoelectric member.

4. The method of claim 3, wherein the polishing of the other surface of the piezoelectric member is performed such that the depth of the seating groove is the same as the height from the basal surface of the seating groove to the other surface of the piezoelectric member.
